(19) United States
(12) Patent Application Publication
(10) Pub. No.: US 2017/0353298 A1
(43) Pub. Date: Dec. 7, 2017

(54) SINGLE CLOCK CYCLE CRYPTOGRAPHIC ENGINE

(71) Applicant: Intel Corporation, Santa Clara, CA (US)

(72) Inventor: SANTOSH GHOSH, Hillsboro, OR (US)

(73) Assignee: Intel Corporation, Santa Clara, CA (US)

(21) Appl. No.: 15/173,492

(22) Filed: Jun. 3, 2016

(51) Int. Cl. H04L 9/06; H04L 9/14; G06F 21/60

(52) U.S. Cl. CPC H04L 9/0631; G06F 21/602; H04L 9/14

(57) ABSTRACT

One embodiment provides an apparatus. The apparatus includes a cryptographic engine to encrypt or decrypt a 64-bit input data block based, at least in part, on a 128-bit input key. The cryptographic engine includes an input stage; a first group of rounds; a middle stage; a second group of inverse rounds and an output stage. Each round includes a first substitution box (“sbox”) stage, a first matrix multiplication stage, a row permutation stage and a first plurality of mixers. Each inverse round includes a second plurality of mixers, an inverse row permutation stage, a second matrix multiplication stage and a second inverse sbox stage. Each sbox stage includes a plurality of sbox portions. Each sbox portion includes a first number of combinational logic gates. Each inverse sbox stage includes a plurality of inverse sbox portions. Each inverse sbox portion includes a second number of combinational logic gates.

### FIELD

The present disclosure relates to a cryptographic engine, in particular to, a single clock cycle cryptographic engine.

### BACKGROUND

Block cipher encryption and decryption may be used to protect digital data. Lightweight cryptographic ciphers may be utilized for Internet of Things (IoT) applications, for example, due to size and energy consumption constraints associated with IoT devices. Energy consumption is directly related to latency and a block cipher with a relatively lower latency may have a corresponding relatively lower energy consumption. Latency is also related to a speed at which a plaintext may be encrypted or a ciphertext may be decrypted.

### BRIEF DESCRIPTION OF DRAWINGS

Features and advantages of the claimed subject matter will be apparent from the following detailed description of embodiments consistent therewith, which description should be considered with reference to the accompanying drawings, wherein:

FIG. 1 illustrates a functional block diagram of a single clock cycle cryptographic engine consistent with several embodiments of the present disclosure;

FIG. 2 illustrates a first round key, k0, to third round key, k0′, conversion structure;

FIG. 3 illustrates a 4-bit portion of a substitution box (sbox) stage;

FIG. 4 illustrates a 4-bit portion of an inverse sbox stage;

FIGS. 5A and 5B are graphical illustrations of row permutation (R) operations and inverse row permutation (R⁻¹) operations, respectively;

FIG. 6 illustrates a combined bit computation datapath including matrix multiplication, mixing a round key and mixing a RC (round constant);

FIG. 7 illustrates a device consistent with several embodiments of the present disclosure; and

FIG. 8 is a flowchart of cryptographic operations according to various embodiments of the present disclosure.

Although the following Detailed Description will proceed with reference being made to illustrative embodiments, many alternatives, modifications, and variations thereof will be apparent to those skilled in the art.

### DETAILED DESCRIPTION

Generally, this disclosure relates to a single clock cycle cryptographic engine. An apparatus, method and/or system are configured to implement, in circuitry, a variant of the PRINCE cryptographic algorithm. The PRINCE cryptographic algorithm is configured to provide relatively “lightweight” cryptographic functionality with a relatively low latency.

The apparatus, method and/or system are configured to encrypt a 64-bit block of data (“plaintext”) or decrypt a 64-bit block of encrypted data (“ciphertext”) in one clock cycle. For example, for 14 nm (nanometer) technology, a duration (i.e., clock period) of one clock cycle is 5 ns (nanoseconds) corresponding to a clock frequency of 200 MHz (Megahertz). Thus, a single clock cycle cryptographic engine, consistent with the present disclosure, may encrypt or decrypt a 64-bit data block in less than or equal to 5 ns when implemented in 14 nm technology. In another example, for 10 nm technology, the clock frequency may be greater than 200 MHz and associated clock cycle duration may be less than 5 ns. In another example, for greater than 14 nm technology, the clock frequency may be less than 200 MHz and the associated clock cycle duration may be greater than 5 ns.

A physical size of the cryptographic engine may be reduced and/or minimized, i.e., a total number of gate equivalents (“gates”) may be reduced and/or minimized relative to a nave implementation, as will be described in more detail below. The total number of gates may be less than 7000 gate equivalents. A length, in gates, of a critical path may be reduced and/or minimized. As used herein, “critical path” corresponds to a longest datapath, i.e., number of gates in series, between an input and an output. The critical path of a cryptographic engine consistent with the present disclosure may include fewer than 200 gates. In one example, the critical path may include at most 110 gates. In another example, the critical path may include at most 100 gates.

For example, each substitution box (“sbox”) and/or inverse sbox may be implemented in circuitry, i.e., combinatorial logic gates, and each sbox or inverse sbox may then contribute five gates to the critical path. In another example, each matrix multiplication stage may implement a binary tree and each matrix multiplication stage may then contribute seven gates to the critical path. In another example, each matrix multiplication stage may be configured to exploit features (characteristics) of the PRINCE multiplication matrix to reduce and/or minimize the length of the critical path. In this example, each matrix multiplication stage may then contribute two gates to the critical path. In another example, a cryptographic engine consistent with the present disclosure may be configured to perform matrix multiplication operations and mixing operations in parallel. In this example, the combined operations may reduce the critical path by one gate per round and/or inverse round, compared to performing the operations serially. Thus, the apparatus, method and/or system may be utilized in devices and/or systems that have size and/or energy consumption constraints, e.g., IoT devices.

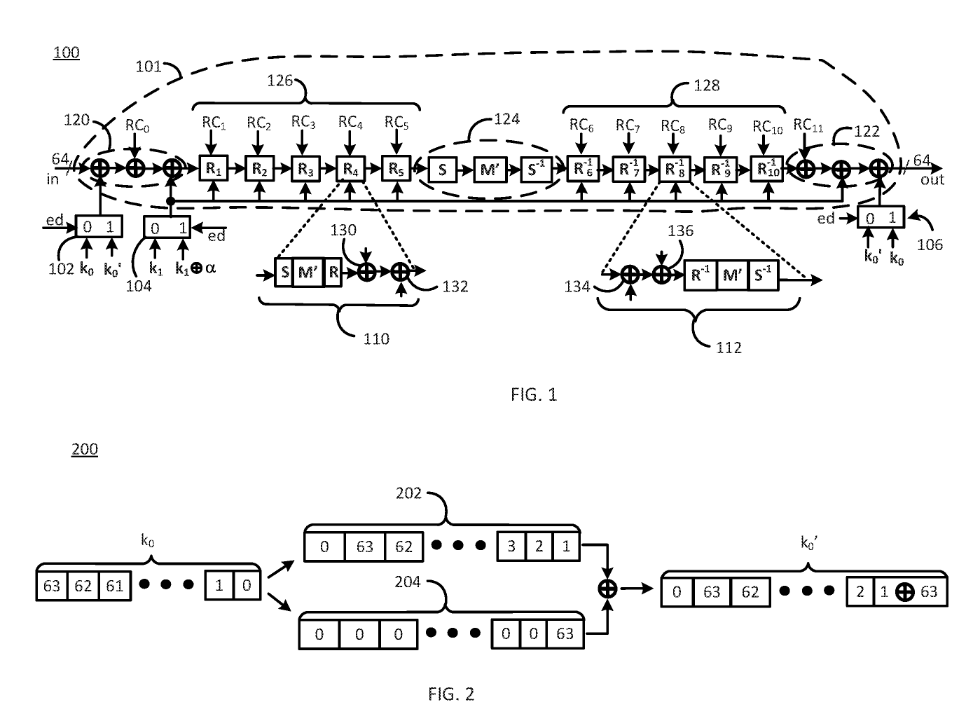

FIG. 1 illustrates a functional block diagram of a single clock cycle cryptographic engine 100 consistent with several embodiments of the present disclosure. The cryptographic engine 100 includes a datapath 101 configured to receive a 64-bit input data block, “in”, and to generate a 64-bit output data block, “out”. The input data block may be plaintext and the corresponding output data block may be ciphertext or the input data block may be ciphertext and the corresponding output data block may be plaintext. The cryptographic engine 100 is configured to encrypt or decrypt the 64 bits of the 64-bit input data block, in parallel. The datapath 101 is configured to contain combinational circuitry (i.e., asynchronous combinatorial logic gates) and interconnect circuitry. The combinatorial circuitry may include AND, OR, exclusive-OR and/or negation logic gates. As used herein, “combinational” and “combinatorial” are used interchangeably, with respect to logic gates.

The cryptographic engine 100 further includes multiplexers (“muxes”) 102, 104 and 106. The muxes 102, 104 and 106 are configured to receive an encryption/decryption selector signal, “ed”, from, e.g., a processor. The muxes are further configured to couple selected round keys (i.e., round cryptographic keys) to datapath 101 elements (e.g., mixers), according to a state of the selector signal. For example, ed equal to logic zero may correspond to encryption and ed equal to logic one may correspond to decryption.

The datapath 101 includes a plurality of datapath elements including an input stage 120, a first group 126 of rounds (R1, R2, R3, R4, R5), a middle stage 124, a second group 128 of inverse rounds (R6⁻¹, R7⁻¹, R8⁻¹, R9⁻¹, R10⁻¹) and an output stage 122. The input data block may be provided to the input stage 120 and the output data block may be output from the output stage 122. The input stage 120 includes three mixers configured to mix the input data block, first and second selected round keys and a round constant, RC0, as will be described in more detail below. As used herein, “mix” means bitwise exclusive-OR (XOR), thus, a mixer may correspond to one or more XOR gates. The output stage 122 includes three mixers configured to mix an output of inverse round R10⁻¹, the second and a third selected round keys and a round constant, RC11, as will be described in more detail below.

Each round of the first group 126 of rounds contains an sbox stage (S), a matrix multiplication stage (M′) and a row permutation stage (R) followed by two mixers configured to mix the second selected round key and a round constant with an intermediate data block, as will be described in more detail below. Each round of the second group 128 of inverse rounds contains two mixers configured to mix the second selected round key and a round constant to an input data block, an inverse row permutation stage (R⁻¹), a matrix multiplication stage (M′) and an inverse sbox stage (S⁻¹), as will be described in more detail below.

The PRINCE cryptographic algorithm is configured to encrypt or decrypt a 64-bit block of plaintext or ciphertext, utilizing a 128-bit input cryptographic key and twelve round constants RCi, i=0, 1, . . . , 11. The twelve round constants and a fourth cryptographic key are related to a constant, α, defined by the PRINCE cryptographic algorithm. The PRINCE cryptographic algorithm utilizes four 64-bit round keys (k0, k1, k0′, k1⊕α) related to the 128-bit input cryptographic key, thus, one round key may be utilized by more than one round, as will be described in more detail below. PRINCE rounds may be implemented as loops, including storing the intermediate values, for twelve iterations. In an embodiment consistent with the present disclosure, encryption or decryption of a data block in one clock cycle is facilitated and storage of intermediate values is avoided.

The PRINCE cryptographic algorithm may be configured to encrypt or decrypt the 64-bit input data block without a warm-up phase. In other words, pipelined cryptographic algorithms may have a warm-up phase between initialization and filling the pipeline. Such warm-up phase may add to the latency associated with encrypting or decrypting a block of data. The PRINCE cryptographic algorithm, implemented as described herein, is configured to encrypt or decrypt the 64-bit input data block without a warm-up phase. Thus, cryptographic engine 100 is configured to encrypt or decrypt any 64-bit input data block within 5 ns when implemented on 14 nm technology.

The cryptographic engine 100 is configured to receive a 128-bit input cryptographic key (“input key”). A total of four 64-bit round cryptographic keys (“round keys”) may be generated based, at least in part, on the received 128-bit input key. The round keys may be generated prior to encrypting or decrypting an input data block by cryptographic engine 100. A first and a second round key, k0 and k1, may correspond to the most significant 64 bits (bits 127 through bits 64) and the least significant 64 bits (bits 63 through bits 0) of the input key, i.e., k0∥k1. A third 64-bit key, k0′, may be generated, according to the PRINCE algorithm, based on the first key, k0, and a fourth 64-bit key (k1⊕α) may be generated based, at least in part, on the second key, k1, as described herein. Thus, the 128-bit cryptographic key input may yield four 64-bit round keys, k0, k1, k0′, k1⊕α. As used herein, ⊕ corresponds to exclusive-OR. The first and second round keys, k0 and k1 may be stored in, e.g., two 64-bit registers. The third and fourth round keys, k0′ and k1⊕α, may be implemented in circuitry.

FIG. 2 illustrates a first round key, k0, to third round key, k0′, conversion structure 200. Conversion structure 200 illustrates generation of the third round key, k0′, based on the first round key, k0, according to the relation k0′=(k0>>>1) ⊕ (k0>>63), where >>> corresponds to rotate right, ⊕ corresponds to exclusive-OR (XOR) and >> corresponds to shift right. Bit structure 202 illustrates a result of rotating the first round key, k0, right one bit. Bit structure 204 illustrates a result of shifting the first round key, k0, right 63 bits. It may be appreciated that in a shifting operation, shifted bits are replaced by logic zeros. The third 64-bit key, k0′, may then correspond to a result of a bitwise exclusive-OR of bit structure 202 and bit structure 204. The 63 most significant bits of the third 64-bit round key k0′ may be implemented in interconnect circuitry, e.g., conductive traces, configured to couple bits 0, 2, 3, . . . , 63 of the first 64-bit key, k0, to the appropriate inputs of muxes 102 and 106 such that the bit configurations of the inputs to the muxes 102, 106 correspond to the third 64-bit key, k0′. The least significant bit that is the result of bit 1 XORed with bit 63 may be implemented in circuitry that includes one XOR gate. The inputs to the XOR gate may be coupled to bits 1 and 63 of k0 and the output of the XOR gate may then be coupled to muxes 102 and 106 by interconnect circuitry.

A constant, α, is defined by the PRINCE algorithm as α=0xc0ac2967c97c50dd. α is related to round constants, as described herein, and is also related to the fourth round key. The fourth round key is a result of exclusive-ORing the second round key, k1, and the constant, α. Mux 104 is configured to receive the second round key, k1, and the fourth round key, k1⊕α. XORing the second key, k1, with the constant, α, may be implemented, in circuitry, by an XOR gate to yield the fourth round key.

The round keys, k0 or k0′, k1 or k1⊕α, and k0′ or k0, selected by mux 102, 104, 106, respectively, and provided to elements of datapath 101, are selected by encryption/decryption select signal, ed. The respective output of each mux 102, 104 and 106 may then be provided to elements of datapath 101. For example, the first mux 102 is configured to receive k0 and k0′, the second mux 104 is configured to receive k1 and k1⊕α and the third mux 106 is configured to receive k0′ and k0. Continuing with this example, if ed is equal to zero (i.e., encryption), k0, k1 and k0′ may be provided to datapath 101 by respective muxes 102, 104 and 106 and if ed is equal to one (i.e., decryption), k0′, k1⊕α and k0 may be provided to datapath 101. It may be appreciated that the muxes 102, 104, 106 do not add gates to the critical path of datapath 101.

Thus, cryptographic engine 100 may be configured to encrypt or decrypt the input data block based, at least in part, on signal ed. In other words, the circuitry included in datapath 101 may be configured to encrypt or decrypt according to a state of selector signal ed and corresponding application of appropriate keys, k0 or k0′, k1 or k1⊕α, and k0′ or k0. Utilizing a same datapath for encryption or decryption may facilitate constraining the size of cryptographic engine 100.

The input stage 120, the first group 126 of rounds (R1, R2, R3, R4, R5), the second group 128 of inverse rounds (R6⁻¹, R7⁻¹, R8⁻¹, R9⁻¹, R10⁻¹) and the output stage 122 are each configured to receive a respective round constant, RCᵢ, i=0, 1, . . . , 11. The round constants are fixed 64-bit values defined by the PRINCE algorithm. Pairs of round constants are related by the constant, α, as α=RCᵢ⊕RC₁₁₋ᵢ, i=0, 1, . . . , 11. Table 1 contains round constants RCᵢ, i=0, 1, . . . , 11, in hexadecimal number format.

TABLE 1

| | |
|---|---|
| RC0 | 0000 0000 0000 0000 |
| RC1 | 1319 8A2E 0370 7344 |
| RC2 | A409 3822 299F 31D0 |
| RC3 | 082E FA98 EC4E 6C89 |
| RC4 | 4528 21E6 38D0 1377 |
| RC5 | BE54 66CF 34E9 0C6C |
| RC6 | 7EF8 4F78 FD95 5CB1 |
| RC7 | 8584 0851 F1AC 43AA |
| RC8 | C882 D32F 2532 3C54 |
| RC9 | 64A5 1195 E0E3 610D |
| RC10 | D3B5 A399 CA0C 2399 |
| RC11 | C0AC 29B7 C97C 50DD |

The round constants are fixed and, thus, may be implemented in circuitry coupled by interconnect circuitry to the input stage 120, the first group 126 of rounds (R1, R2, R3, R4, R5), the second group 128 of inverse rounds (R6⁻¹, R7⁻¹, R8⁻¹, R9⁻¹, R10⁻¹) and the output stage 122. Interconnect circuitry may include, but is not limited to, conductive traces, wires, etc.

The input stage 120 includes three mixers coupled in series. The input stage is configured to receive the 64-bit input data block, in, an output of the first mux 102 (k0 or k0′, i.e., the first or third round key), the round constant, RC0, and an output of the second mux 104 (k1 for encryption or k1⊕α for decryption, i.e., the second or fourth round key). The input stage 120 is configured to mix (i.e., XOR) the received 64-bit data block with two selected round keys and the round constant RC0. The two selected round keys are k0 and k1 if encryption/decryption selector signal, ed, is zero or k0′ and k1⊕α if ed is one. An output of the input stage 120, i.e., a 64-bit input stage intermediate output, is coupled to round R1 of the first group 126 of rounds. The output of the input stage, i.e., the 64-bit input stage intermediate output, may then be provided to the first round, R1, of the first group 126 of rounds. The three mixers included in the input stage 120 may be implemented as exclusive-OR (i.e., XOR) gates. Thus, the input stage 120 may contribute three gates to the critical path of datapath 101.

The first group 126 of rounds includes five rounds, R1, R2, R3, R4 and R5 coupled in series. An input of round R1 is coupled to an output of the input stage 120 and an output of round R1 is coupled to an input of round R2. An output of round R2 is coupled to an input of round R3 and an output of round R3 is coupled to an input of round R4. An output of round R4 is coupled to an input of round R5 and an output of round R5 is coupled to an input of the middle stage 124. Thus, the first group 126 of rounds is configured to receive the 64-bit input stage intermediate output and to provide a 64-bit first group intermediate output to the middle stage 124.

Each round R1, R2, R3, R4, R5 is configured to receive a respective round constant RC1, RC2, RC3, RC4, RC5. Each round R1, R2, R3, R4, R5 is further configured to receive an output of the second mux 104 (i.e., k1 or k1⊕α, the second or fourth round keys). Each round R1, R2, R3, R4 and R5 contains round circuitry 110. Round circuitry 110 contains an sbox stage, S, a matrix multiplication stage, M′, a row permutation stage, R, a first mixer (i.e., XOR gate) 130 and a second mixer 132. The first mixer 130 is configured to receive the respective round constant and the second XOR gate 132 is configured to receive the selected round key k1 or k1⊕α. The mixers 130, 132 may each contribute two gates to the critical path of datapath 101, thus, the XOR gates included in the five rounds of the first group 126, may contribute ten gates to the critical path.

An input of the middle stage 124 is coupled to an output of round R5 and an output of the middle stage 124 is coupled to in input of inverse round R6⁻¹. The middle stage 124 contains an sbox stage, S, a matrix multiplication stage, M′, and an inverse sbox stage, S⁻¹. Thus, the middle stage 124 is configured to receive the 64-bit first group intermediate output and to provide a 64-bit middle stage intermediate output to the second group 128.

The second group 128 of inverse rounds includes five inverse rounds, R6⁻¹, R7⁻¹, R8⁻¹, R9⁻¹, R10⁻¹, coupled in series. An input of inverse round R6⁻¹ is coupled to an output of the middle stage 124 and an output of inverse round R6⁻¹ is coupled to an input of inverse round R7⁻¹. An output of inverse round R7⁻¹ is coupled to an input of inverse round R8⁻¹ and an output of inverse round R8⁻¹ is coupled to an input of inverse round R9⁻¹. An output of inverse round R9⁻¹ is coupled to an input of inverse round R10⁻¹ and an output of inverse round R10⁻¹ is coupled to an input of the output stage 122. Thus, the second group 128 of inverse rounds is configured to receive the 64-bit middle stage intermediate output and to provide a 64-bit second group intermediate output to the output stage 122.

Each inverse round R6⁻¹, R7⁻¹, R8⁻¹, R9⁻¹, R10⁻¹ is configured to receive a respective round constant RC6, RC7, RC8, RC9, RC10. Each inverse round R6⁻¹, R7⁻¹, R8⁻¹, R9⁻¹, R10⁻¹ is further configured to receive an output of the second mux 104 (i.e., k1 for encryption or k1⊕α for decryption). Each inverse round R6⁻¹, R7⁻¹, R8⁻¹, R9⁻¹, R10⁻¹ contains inverse round circuitry 112. Inverse round circuitry 112 contains a first mixer (i.e., XOR gate) 134, a second mixer 136, an inverse row permutation stage, R⁻¹, the matrix multiplication stage, M′ and an inverse sbox stage, S⁻¹. The first mixer 134 is configured to receive the output of the second mux 104 and the second mixer 136 is configured to receive the respective round constant. The two mixers 134, 136 may each contribute two gates to the critical path that corresponds to datapath 101, thus, the XOR gates included in the five inverse rounds of the second group 128 may contribute ten gates to the critical path.

The output stage 122 includes three mixers coupled in series. The output stage is configured to receive an output from inverse round, R10⁻¹, an output of the second mux 104 (i.e., k1 for encryption or k1⊕α for decryption), the round constant, RC11, and an output of the third mux 106 (i.e., k0′ for encryption or k0 for decryption). An output of the output stage 122 corresponds to the 64-bit output data block, out. The output stage 122 contributes three gates (i.e., the three mixers included in the output stage 122) to the critical path of datapath 101.

Thus, the output stage 122 is configured to receive the second group intermediate output data block and to mix (i.e., XOR) the received 64-bit intermediate data block with two selected round keys and the round constant RC11. The two selected round keys are k1 and k0′ if encryption/decryption selector signal, ed, is zero or k1⊕α and k0 if ed is one. A 64-bit output data block may then be output from cryptographic engine 100.

Thus, cryptographic engine 100 includes the input stage 120, the first group 126 of rounds, the middle stage 124, the second group 128 of inverse rounds and the output stage 122. Each round of the first group 126 includes respective round circuitry 110 and each inverse round of the second group 128 includes respective inverse round circuitry 110. The middle stage 124 and the round circuitry 110 each contain a respective sbox stage, S. The middle stage 124, the round circuitry 110 and inverse round circuitry 112 each contain a respective matrix multiplication stage, M′. The middle stage 124 and inverse round circuitry 112 each contain an inverse sbox stage S⁻¹. Round circuitry 110 and inverse round circuitry 112 each contain a row permutation stage, R, or an inverse row permutation stage, R⁻¹, respectively.

Each sbox stage, S, and each inverse sbox stage, S⁻¹, is configured to receive a 64-bit data block. Each sbox stage and inverse sbox stage is configured to implement sixteen 4-bit to 4-bit substitutions, for 64-bits total. Each 4-bit to 4-bit substitutions may be implemented by an sbox portion for an sbox stage, S or an inverse sbox portion for an inverse sbox stage, S⁻¹. Thus, for a 64-bit input, sixteen sbox portions may be implemented in parallel and sixteen inverse sbox portions may be implemented in parallel. Each sbox portion and each inverse sbox portion is configured to operate on one nibble, i.e., 4-bits.

Table 2 illustrates one example sbox substitution relationship. In Table 2, the top row corresponds to a 4-bit input, x, in hexadecimal format and the bottom row corresponds to a related 4-bit output, S(x), in hexadecimal format, for an sbox. For an inverse sbox, the bottom row of Table 2 corresponds to a 4-bit input, x, to the inverse sbox and the top row corresponds to the related 4-bit output, S⁻¹(x).

TABLE 2

| | | | | | | | | | | | | | | | | |
|---|---|---|---|---|---|---|---|---|---|---|---|---|---|---|---|---|
| x or S⁻¹(x) | 0 | 1 | 2 | 3 | 4 | 5 | 6 | 7 | 8 | 9 | A | B | C | D | E | F |
| S(x) or x | B | F | 3 | 2 | A | C | 9 | 1 | 6 | 7 | 8 | 0 | E | 5 | D | 4 |

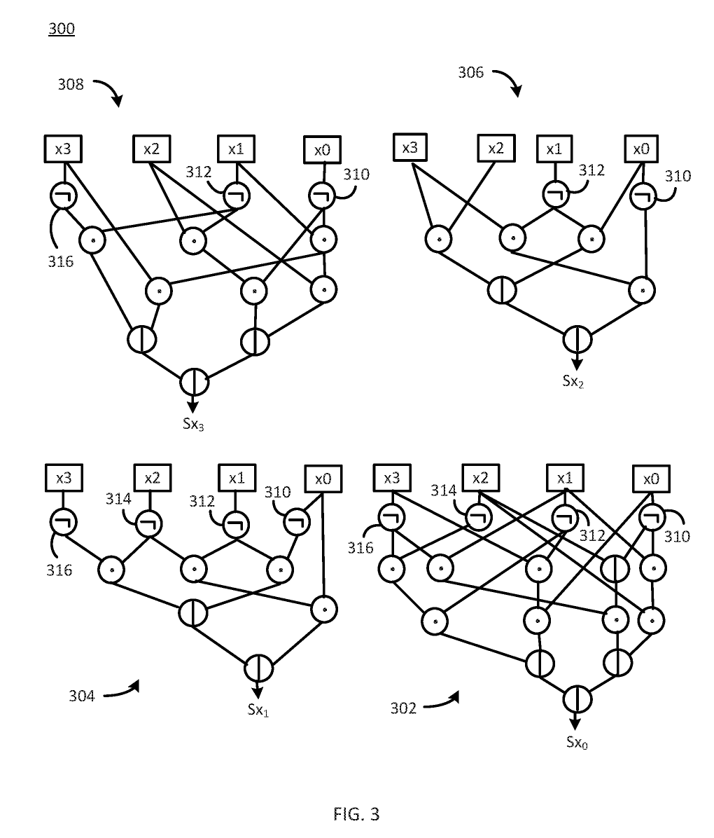

FIG. 3 illustrates a portion 300 of an sbox stage. Sbox portion 300 is configured to receive a 4-bit input and to provide a corresponding 4-bit output. The 4-bit input is illustrated as x0, x1, x2, x3 and the four bit output is illustrated as Sx0, Sx1, Sx2, Sx3. Sbox portion 300 includes four combinational logic circuits 302, 304, 306, 308. A 64-bit sbox may thus include sixteen of each combinational logic circuit 302, 304, 306 and 308. Sbox portion 300 includes a plurality of combinational logic gates including, but not limited to AND, OR and logical negation (i.e., toggle). Logical AND corresponds to a circle with a center dot, logical OR corresponds to circle containing a vertical line and logical negation corresponds to a circle containing “ [symbol] ”.

Each of the four combinational logic circuits 302, 304, 306, 308 is configured to implement a respective one of the following sbox equations. Thus, combinational logic circuit 302 is configured to implement equation Sx₀, combinational logic circuit 304 is configured to implement equation Sx₁, combinational logic circuit 306 is configured to implement equation Sx₂ and combinational logic circuit 308 is configured to implement equation Sx₃.

Sx₀= [symbol] (x₃+x₂+x₁)+(x₃· [symbol] x₁·x₀)+( [symbol] x₃·x₂·x₁)+( [symbol] x₃·x₁· [symbol] x₀)+(x₂·x₁· [symbol] x₀)

Sx₁= [symbol] (x₃+x₂)+ [symbol] (x₁+x₀)+( [symbol] x₂· [symbol] x₁·x₀)

Sx₂=(x₃·x₂)+( [symbol] x₁·x₀)+(x₃· [symbol] x₁· [symbol] x₀)

Sx₃= [symbol] (x₃+x₁)+(x₂· [symbol] x₁· [symbol] x₀)+(x₃·x₁· [symbol] x₀)+(x₂·x₁· [symbol] x₀)

It should be noted that the four combinational logic circuits 302, 304, 306, 308 are shown separately for ease of illustration and to facilitate understanding. Thus, each input bit x0, x1, x2, x3 may be associated with one respective logical negation 310, 312, 314, 316, for the sbox portion 300. Each sbox portion, e.g., sbox portion 300, may thus include 37 combinatorial logic gates. A longest serially connected path for sbox portion 300 includes a maximum of five logic gates, thus, contributing five logic gates to the critical path of datapath 101 for each sbox stage, S. The longest serially connected path begins with input bit x0, x1, x2 or x3 and ends with an associated output bit Sx0, Sx1, Sx2, Sx3.

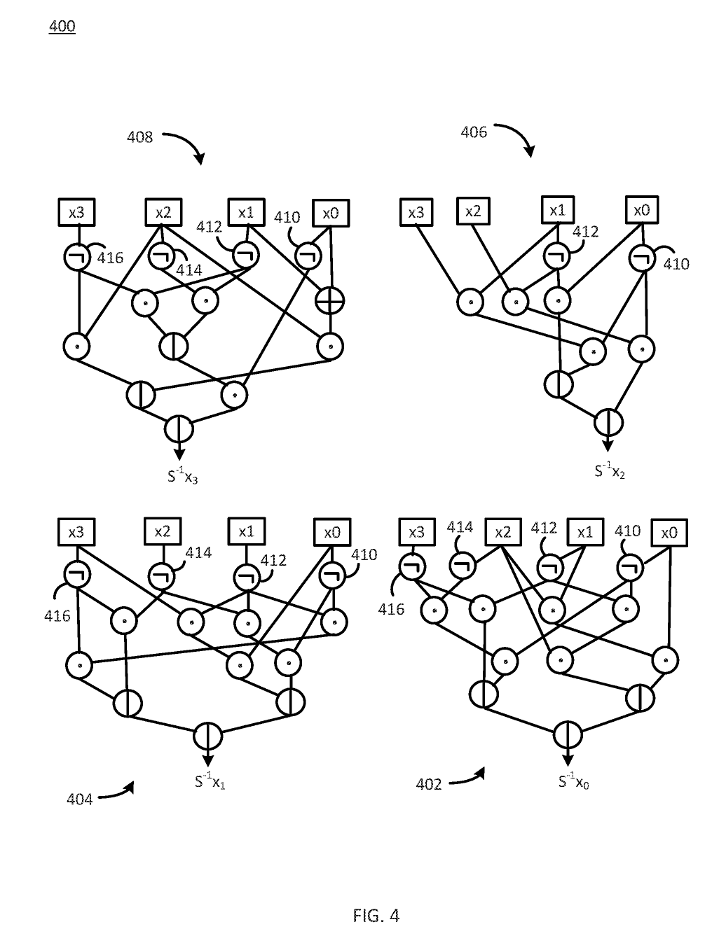

FIG. 4 illustrates a portion 400 of an inverse sbox stage. Similar to sbox stage portion 300, inverse sbox stage portion 400 is configured to receive a 4-bit input and to provide a corresponding 4-bit output. The 4-bit input is illustrated as x0, x1, x2, x3 and the four bit output is illustrated as S⁻¹x0, S⁻¹x1, S⁻¹x2, S⁻¹x3. Inverse sbox portion 400 includes four combinational logic circuits 402, 404, 406, 408. A 64-bit S box may thus include sixteen of each combinational logic circuit 402, 404, 406 and 408. Portion 400 includes a plurality of combinational logic gates including, but not limited to AND, OR and logical negation (i.e., toggle).

Each of the four combinational logic circuits 402, 404, 406, 408 is configured to implement a respective one of the following inverse sbox equations. Thus, combinational logic circuit 402 is configured to implement equation Sx⁻¹₀, combinational logic circuit 404 is configured to implement equation Sx⁻¹₁, combinational logic circuit 406 is configured to implement equation Sx⁻¹₂ and combinational logic circuit 408 is configured to implement equation Sx⁻¹₃.

Sx⁻¹₀= [symbol] (x₃+x₁)+(x₂· [symbol] x₁· [symbol] x₀)+(x₂·x₁·x₀)+ [symbol] (x₃+x₂+x₀)

Sx⁻¹₁= [symbol] (x₃+x₂)+ [symbol] (x₃+x₁+x₀)+ [symbol] (x₂+x₁+x₀)+(x₃· [symbol] x₁·x₀)

Sx⁻¹₂=( [symbol] x₁·x₀)+(x₂· [symbol] x₁· [symbol] x₀)+(x₃·x₁· [symbol] x₀)

Sx⁻¹₃=( [symbol] x₃·x₂)+ [symbol] (x₃+x₁+x₀)+ [symbol] (x₂+x₁+x₀)+(x₂· [symbol] x₁·x₀)+(x₂·x₁· [symbol] x₀)

It should be noted that the four combinational logic circuits 402, 404, 406, 408 are shown separately for ease of illustration and to facilitate understanding. Thus, each input bit x0, x1, x2, x3 may be associated with one respective logical negation 410, 412, 414, 416 for the inverse sbox portion 400. Each inverse inverse sbox portion, e.g., sbox portion 400, may thus include 40 combinatorial logic gates. A longest serially connected path includes a maximum of five logic gates, thus, contributing five logic gates to the critical path of datapath 101 for each inverse sbox stage, S⁻¹.

Thus, each sbox stage, S, and each inverse sbox stage, S⁻¹, may be implemented in circuitry including a plurality of sbox portions and a plurality of inverse sbox portions. Each sbox stage, S, and each inverse sbox stage, S⁻¹, may contribute five gates, respectively, to the critical path of datapath 101.

Each matrix multiplication stage, M′, is configured to multiply a 64-bit input vector (i.e., 64-bit data block) by a 64 by 64 multiplication matrix, M. The PRINCE cryptographic algorithm defines the multiplication matrix, M, based on four 4-bit by 4-bit sub-matrices, M₀, M₁, M₂, M₃. M₀, M₁, M₂, M₃ are defined as:

$${M}_{0} = ( \begin{matrix}0000 \\ 0100 \\ 0010 \\ 0001\end{matrix} ) , {M}_{1} = ( \begin{matrix}1000 \\ 0000 \\ 0010 \\ 0001\end{matrix} ) , {M}_{2} = ( \begin{matrix}1000 \\ 0100 \\ 0000 \\ 0001\end{matrix} ) , {M}_{3} = ( \begin{matrix}1000 \\ 0100 \\ 0010 \\ 0000\end{matrix} ) .$$

The PRINCE cryptographic algorithm further defines two 16-bit by 16-bit matrices \hat{M}⁽⁰⁾,\hat{M}⁽¹⁾, where each row and each column is a permutation of the four sub-matrices, M₀, M₁, M₂, M₃, as:

$${\hat{M}}^{( 0 )} = ( \begin{matrix}{M}_{0} {M}_{1} {M}_{2} {M}_{3} \\ {M}_{1} {M}_{2} {M}_{3} {M}_{0} \\ {M}_{2} {M}_{3} {M}_{0} {M}_{1} \\ {M}_{3} {M}_{0} {M}_{1} {M}_{2}\end{matrix} ) , {\hat{M}}^{( 1 )} = ( \begin{matrix}{M}_{1} {M}_{2} {M}_{3} {M}_{0} \\ {M}_{2} {M}_{3} {M}_{0} {M}_{1} \\ {M}_{3} {M}_{0} {M}_{1} {M}_{2} \\ {M}_{0} {M}_{1} {M}_{2} {M}_{3}\end{matrix} ) .$$

The multiplication matrix, M, may then be constructed utilizing the two 16-bit by 16-bit matrices \hat{M}⁽⁰⁾,\hat{M}⁽¹⁾ as:

$$M = ( \begin{matrix}{\hat{M}}^{( 0 )} & & 0 & … & 0 & … & 0 \\ 0 & & {\hat{M}}^{( 1 )} & & 0 & & 0 \\ 0 & … & 0 & & {\hat{M}}^{( 1 )} & & 0 \\ 0 & … & 0 & … & 0 & & {\hat{M}}^{( 0 )}\end{matrix} ) .$$

In other words, the two 16-bit by 16-bit matrices \hat{M}⁽⁰⁾,\hat{M}⁽¹⁾ occupy the diagonal of multiplication matrix, M, and the remaining matrix elements are all zeros.

It may be appreciated that binary multiplication of a vector by a matrix produces a vector result. For example, binary multiplication of a 64-bit vector by a 64-bit by 64-bit matrix produces a 64-bit vector result. Each element of the vector result is a result of XORing elements of a row of the matrix that have been ANDed with corresponding elements of the vector. In other words, in binary multiplication of a vector by a matrix, multiplication corresponds to a logical AND and addition corresponds to a logical exclusive-OR (XOR) operation.

A naïve matrix multiplication of a vector by a matrix may be implemented utilizing 64×64 AND gates plus 64×63 XOR gates, i.e., 8128 logic gates. A critical path associated with such a nave multiplication may include 64 logic gates.

In an embodiment, the multiplication of an intermediate data block and the multiplication matrix, M, by multiplication stage, M′, may be implemented utilizing a binary tree approach. For each vector result, the binary tree approach is configured to perform AND operations of elements of rows of the multiplication matrix and corresponding elements of the data block in parallel and at least a portion of subsequent XOR operations, in parallel. Each group of parallel operations corresponds to a “level”. Initially, in level 1, each element of a row of multiplication matrix elements is ANDed with a corresponding element of the 64-bit intermediate data block, i.e., input data block (e.g., vector) to the matrix multiplication stage, M′, to produce 64 level 1 intermediate elements. In level 2, pairs of adjacent level 1 intermediate elements are XORed to produce 32 level 2 intermediate elements. As used herein, “adjacent” corresponds to relative element location in the data block vector and/or level result. In level 3, pairs of adjacent level 2 intermediate elements are XORed to produce 16 level 3 intermediate elements. The operations are repeated at each subsequent level through and including level 7 that produces a one element result. The one element result is one element of the 64-bit result vector. The 64-bit result vector is the 64-bit output data block of the matrix multiplication stage, M′. Thus, circuitry, e.g., matrix multiplication block M′, configured to implement a binary tree may include seven levels. The seven levels correspond to sequential operations and may thus contribute seven gates to the critical path of datapath 101 for each matrix multiplication stage, M′. For example, cryptographic engine 100 may include five matrix multiplication stages in the first group 126, five matrix multiplication stages in the second group 128 and one matrix multiplication stage in the middle stage 124, for a total of eleven matrix multiplication stages in the critical path. Thus, a matrix multiplication stage configured to implement a binary tree approach may contribute 77 gates to the critical path of datapath 101.

In another embodiment, the matrix multiplication may be implemented based, at least in part, on characteristics of the multiplication matrix, M. The multiplication matrix, M, as defined by the PRINCE algorithm, includes three nonzero bits in each row. Thus, each output bit of a matrix-intermediate data block multiplication, as described herein, is related to respective values of three bits (i.e., elements) of the intermediate data block. In other words, each output bit corresponds to two XOR operations on the three bits of the intermediate data block. Table 3 contains each output bit, m′xₙ, n=0, 1, . . . , 63, for a 64-bit output vector (i.e., matrix multiplication stage output data block) associated with a respective three input bit values, xᵢ, xⱼ, xₖ, i, j, k=0, 1, . . . , or 63, i≠j≠k. For each output bit, m′xₙ, i, j and k may be determined, a prori, based, at least in part, on the multiplication matrix, M. Table 3 may then be implemented in circuitry that includes interconnect circuitry from a prior stage (i.e., output from the prior stage) and combinational circuitry, i.e., XOR gates.

TABLE 3

| | | | |
|---|---|---|---|
| m′x₆₃ = x₅₉⊕x₅₅⊕x₅₁ | m′x₄₇ = x₄₇⊕x₄₃⊕x₃₉ | m′x₃₁ = x₃₁⊕x₂₇⊕x₂₃ | m′x₁₅ = x₁₁⊕x₇⊕x₃ |
| m′x₆₂ = x₆₂⊕x₅₄⊕x₅₀ | m′x₄₆ = x₄₂⊕x₃₈⊕x₃₄ | m′x₃₀ = x₂₆⊕x₂₂⊕x₁₈ | m′x₁₄ = x₁₄⊕x₆⊕x₂ |
| m′x₆₁ = x₆₁⊕x₅₇⊕x₄₉ | m′x₄₅ = x₄₅⊕x₃₇⊕x₃₃ | m′x₂₉ = x₂₉⊕x₂₁⊕x₁₇ | m′x₁₃ = x₁₃⊕x₉⊕x₁ |
| m′x₆₀ = x₆₀⊕x₅₆⊕x₅₂ | m′x₄₄ = x₄₄⊕x₄₀⊕x₃₂ | m′x₂₈ = x₂₈⊕x₂₄⊕x₁₆ | m′x₁₂ = x₁₂⊕x₁₈⊕x₄ |
| m′x₅₉ = x₆₃⊕x₅₉⊕x₅₅ | m′x₄₃ = x₄₇⊕x₄₃⊕x₃₅ | m′x₂₇ = x₃₁⊕x₂₇⊕x₁₉ | m′x₁₁ = x₁₅⊕x₁₁⊕x₇ |
| m′x₅₈ = x₅₈⊕x₅₄⊕x₅₀ | m′x₄₂ = x₄₆⊕x₄₂⊕x₃₈ | m′x₂₆ = x₃₀⊕x₂₆⊕x₂₂ | m′x₁₀ = x₁₀⊕x₆⊕x₂ |
| m′x₅₇ = x₆₁⊕x₅₃⊕x₄₉ | m′x₄₁ = x₄₁⊕x₃₇⊕x₃₃ | m′x₂₅ = x₂₅⊕x₂₁⊕x₁₇ | m′x₉ = x₁₃⊕x₅⊕x₁ |
| m′x₅₆ = x₆₀⊕x₅₆⊕x₄₈ | m′x₄₀ = x₄₄⊕x₃₆⊕x₃₂ | m′x₂₄ = x₂₈⊕x₂₀⊕x₁₆ | m′x₈ = x₁₂⊕x₈⊕x₀ |
| m′x₅₅ = x₆₃⊕x₅₉⊕x₅₁ | m′x₃₉ = x₄₇⊕x₃₉⊕x₃₅ | m′x₂₃ = x₃₁⊕x₂₃⊕x₁₉ | m′x₇ = x₁₅⊕x₁₁⊕x₃ |
| m′x₅₄ = x₆₂⊕x₅₈⊕x₅₄ | m′x₃₈ = x₄₆⊕x₄₂⊕x₃₄ | m′x₂₂ = x₃₀⊕x₂₆⊕x₁₈ | m′x₆ = x₁₄⊕x₁₀⊕x₆ |
| m′x₅₃ = x₅₇⊕x₅₃⊕x₄₉ | m′x₃₇ = x₄₅⊕x₄₁⊕x₃₇ | m′x₂₁ = x₂₉⊕x₂₅⊕x₂₁ | m′x₅ = x₉⊕x₅⊕x₁ |
| m′x₅₂ = x₆₀⊕x₅₂⊕x₄₈ | m′x₃₆ = x₄₀⊕x₃₆⊕x₃₂ | m′x₂₀ = x₂₄⊕x₂₀⊕x₁₆ | m′x₄ = x₁₂⊕x₄⊕x₀ |
| m′x₅₁ = x₆₃⊕x₅₅⊕x₅₁ | m′x₃₅ = x₄₃⊕x₃₉⊕x₃₅ | m′x₁₉ = x₂₇⊕x₂₃⊕x₁₉ | m′x₃ = x₁₅⊕x₇⊕x₃ |
| m′x₅₀ = x₆₂⊕x₅₈⊕x₅₀ | m′x₃₄ = x₄₆⊕x₃₈⊕x₃₄ | m′x₁₈ = x₃₀⊕x₂₂⊕x₁₈ | m′x₂ = x₁₄⊕x₁₀⊕x₂ |
| m′x₄₉ = x₆₁⊕x₅₇⊕x₅₃ | m′x₃₃ = x₄₅⊕x₄₁⊕x₃₃ | m′x₁₇ = x₂₉⊕x₂₅⊕x₁₇ | m′x₁ = x₁₃⊕x₉⊕x₅ |
| m′x₄₈ = x₅₆⊕x₅₂⊕x₄₈ | m′x₃₂ = x₄₄⊕x₄₀⊕x₃₆ | m′x₁₆ = x₂₈⊕x₂₄⊕x₂₀ | m′x₀ = x₈⊕x₄⊕x₀ |

In the embodiment related to Table 3, matrix multiplication stage, M′, may include 128 XOR gates arranged in pairs. Each pair of XOR gates is configured to receive a respective three input bits of the input vector, i.e., the 64-bit intermediate data block. For example, each pair of XOR gates may be coupled, i.e., interconnected, to appropriate outputs (i.e., output bits) of a preceding stage. A first XOR gate in each pair of XOR gates is configured to receive a two bits of the respective three input bits. A second XOR gate in the pair of XOR gates is configured to receive an output of the first XOR gate and the third bit of the respective three input bits. Thus, in this embodiment, each matrix multiplication stage may contribute two gates and eleven multiplication stages may contribute twenty two gates to the critical path of datapath 101.

Thus, each matrix multiplication stage, M′, may be configured to multiply a 64-bit input data block, e.g., intermediate data block, by multiplication matrix, M. A number of gates included in the matrix multiplication stage, M′, and a number of gates contributed to the critical path 101, is related to a configuration of the matrix multiplication stage, as described herein.

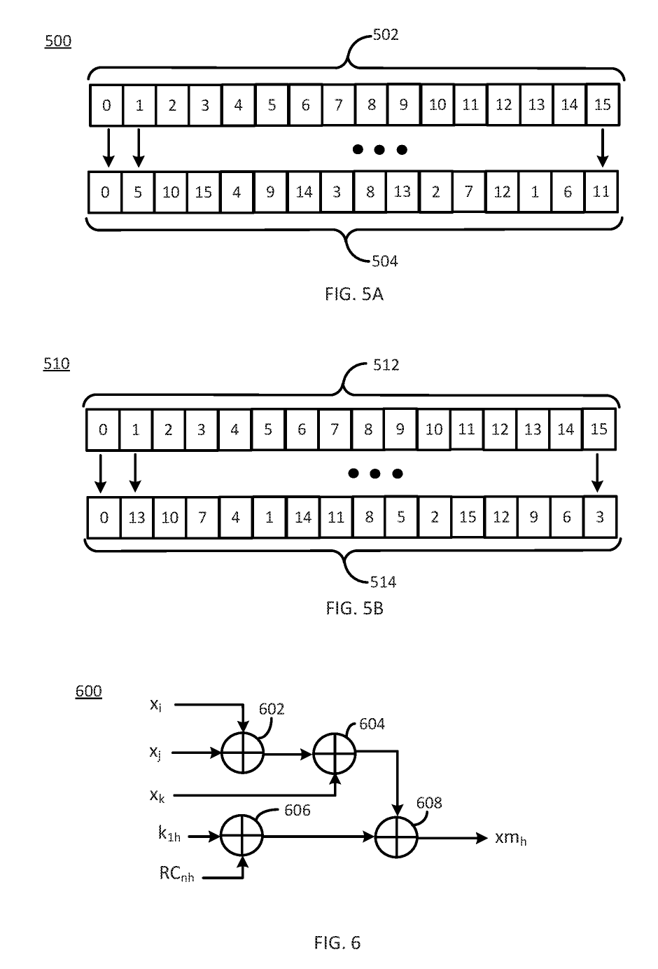

FIGS. 5A and 5B are graphical illustrations of row permutation 500 operations associated with row permutation stage, R, and inverse row permutation 510 operations associated with inverse row permutation stage, R⁻¹, respectively. Row permutation graphical illustration 500 includes nibble locations 502 of the 64-bit intermediate data block input to a corresponding row permutation stage, R. Row permutation graphical illustration 500 further includes resulting nibble locations 504 of the 64-bit intermediate data block output from the corresponding row permutation stage. For example, nibble position 0 for the input 502 remains in nibble position 0 for the output 504. In another example, nibble position 1 for the input 502 permutes to nibble position 5 for the output 504. In another example, nibble position 2 for the input 502 permutes to nibble position 10 for the output 504. Thus, the numerals included in the output graphical illustration 504 correspond to a resulting nibble position for the nibbles indexed by input graphical illustration 502.

Similarly, inverse row permutation graphical illustration 510 includes nibble locations 512 of the 64-bit intermediate data block input to a corresponding inverse row permutation stage, R⁻¹. Inverse row permutation graphical illustration 510 further includes resulting nibble locations 514 for the 64-bit intermediate data block output from the corresponding inverse row permutation stage. For example, nibble position 1 for the input 512 permutes to nibble position 13 for the output 514. In another example, nibble position 2 for the input 512 permutes to nibble position 10 for the output 514. Thus, the numerals included in the inverse output graphical illustration 514 correspond to a resulting nibble position for the nibbles indexed by the input inverse graphical illustration 512.

The row permutations and inverse row permutations included in graphical illustrations 500 and 510 may be implemented by interconnect circuitry between input bit positions and output bit positions. For example, interconnect circuitry may include, but are not limited to, conductive traces, wires, etc. The row permutations and inverse row permutations and associated interconnect circuitry may thus not contribute gates to the critical path of datapath 101.

Turning again to FIG. 1, round circuitry 110 includes an sbox stage, S, a matrix multiplication stage, M′, and a row permutation stage, R. Inverse round circuitry 112 includes an inverse row permutation stage, R⁻¹, a matrix multiplication stage, M′, and an inverse sbox stage, S⁻¹. Round circuitry 110 and inverse round circuitry 112 are each further configured to mix a selected round constant and a selected round key with a received intermediate data block. In an embodiment, mixing the selected round constant and selected round key may be performed in parallel with matrix multiplication operations. In this embodiment, the portion of the critical path associated with round circuitry 110 or inverse round circuitry 112 may be reduced compared to an implementation of round circuitry 110 or inverse round circuitry 112 that does not implement these operations in parallel.

FIG. 6 illustrates a combined bit computation datapath 600 including matrix multiplication mixing a round key and mixing a RC (round constant). The combined bit computation datapath 600 includes four XOR gates, 602, 604, 606, 608, for each bit of the input data block, i.e., 256 XOR gates for a 64-bit input data block. In an embodiment, the critical path that includes the matrix multiplication stage, M′, as well as the round constant and round key mixing may include three gates when the matrix multiplication stage, M′, is implemented according to Table 3, as described herein.

XOR gates 602 and 604 correspond to matrix multiplication as described herein with respect to Table 3. A first XOR gate 602 is configured to receive two of the three input bits, xi and xj. A second XOR gate 604 is configured to receive an output from the first XOR gate 602 and the third bit, xk, of the three input bits. A third XOR gate 606 is configured to receive a corresponding bit of the round key, klh, and a corresponding bit of the round constant, RCnh. A fourth XOR gate 608 is configured to receive an output of the second XOR gate 604 and an output of the third XOR gate 606. An output, xmh, of XOR gate 606 corresponds to one bit output, h=0, 1, 2, . . . , 63. Thus, the operations of the first and second XOR gates 602 and 604 may be performed in parallel with the operations of the third XOR gate 606. In other words, the matrix multiplication of matrix multiplication stage, M′, may be performed in parallel with mixing the round key and the selected round constant, thus reducing the critical path by at least one gate compared to performing the operations serially. It may be appreciated that a combined matrix multiplication and key and round constant mixing stage may include 64 of combined computation datapath circuitry 600.

For the first group 126, the mixing and matrix multiplication operations performed in parallel correspond to a same round, e.g., round R1, R2, R3, R4, R5. For the second group 128, the mixing corresponds to a subsequent inverse round (or output stage 122 for inverse round R10⁻¹) relative to the matrix multiplication operations, e.g., matrix multiplication for inverse round R6⁻¹ and mixing of inverse round R7⁻¹, etc.

Thus, cryptographic engine 100 may be configured to implement a variant of the PRINCE algorithm. A number of gates and thus, size, of the cryptographic engine 100 implementation and/or a number of gates in the critical path may be constrained by, e.g., implementing the sbox stages and inverse sbox stages as described herein. The number of gates and associated size may be reduced by exploiting characteristics of the multiplication matrix, M, utilizing a binary tree and/or combining multiplication and key and round constant mixing. A 64-bit data block may be encrypted or decrypted in one clock cycle, e.g., in less than or equal to 5 ns for a 14 nm technology implementation. A same datapath circuitry may be used for encryption or decryption based, at least in part, on outputs from three muxes, each configured to receive two round keys. Thus, a cryptographic engine consistent with the present disclosure may be implemented in a size and/or energy consumption constrained device, e.g., an IoT device.

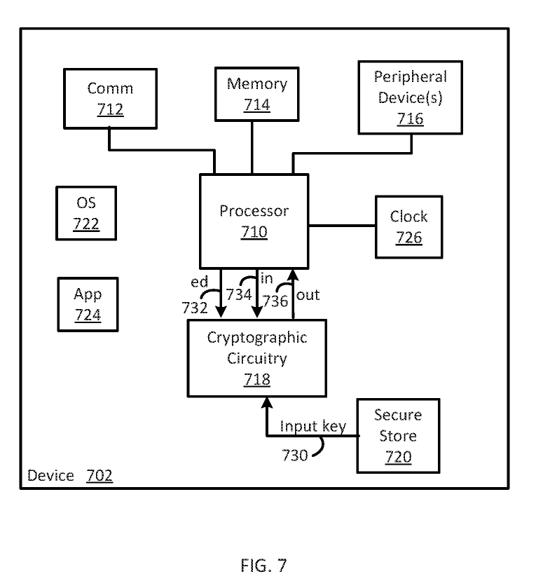

FIG. 7 illustrates a device 702 consistent with several embodiments of the present disclosure. Device 702 includes a processor 710, communication circuitry 712, memory 714, peripheral devices 716 and a clock 726. Device 702 further includes cryptographic circuitry 718 and secure store 720. Device 702 may further include an operating system (OS) 722 and/or one or more applications, e.g., app 724. For example, cryptographic circuitry 718 may correspond to the single clock cycle cryptographic engine 100 of FIG. 1.

Device 702 may include, but is not limited to, a mobile telephone including, but not limited to a smart phone (e.g., iPhone®, Android®-based phone, Blackberry®, Symbian®-based phone, Palm®-based phone, etc.); a wearable device (e.g., wearable computer, “smart” watches, smart glasses, smart clothing, etc.) and/or system; an Internet of Things (IoT) networked device including, but not limited to, a sensor system (e.g., environmental, position, motion, etc.) and/or a sensor network (wired and/or wireless); a computing system (e.g., a server, a workstation computer, a desktop computer, a laptop computer, a tablet computer (e.g., iPad®, GalaxyTab® and the like), an ultraportable computer, an ultramobile computer, a netbook computer, a phablet computer and/or a subnotebook computer; etc.

Processor 710 may contain one or more processing units and is configured to perform operations associated with device 702. Communication circuitry 712 is configured to provide communication capability, wired and/or wireless, to device 702. Peripheral devices 716 may include, but are not limited to, user input devices (e.g., keyboard, a keypad, touchpad, mouse, microphone, etc.), a display (including a touch sensitive display), external storage devices, etc.

Clock 726 is configured to provide a clock input to processor 710. The clock 726 has an associated clock frequency and a corresponding clock cycle, i.e., clock period. For example, the clock frequency may be 200 MHz with a corresponding clock cycle of 5 ns. In another example, the clock frequency may be greater than or less than 200 MHz and the clock cycle may be less than or greater than 5 ns.

In operation, cryptographic circuitry 718 may be configured to encrypt or decrypt data associated with OS 722 and/or app 724. Cryptographic circuitry 718 may be configured to encrypt or decrypt a 64-bit input data block 734 based, at least in part, on a state of ed signal 732. For example, ed=0 may correspond to encryption and ed=1 may correspond to decryption. The 64-bits of the input data block 734 may be provided to cryptographic circuitry 718 by, e.g., processor 710, in parallel. Cryptographic circuitry 718 is further configured to receive an input cryptographic key 730 from the secure store 720. For example, the input key may be a 128-bit cryptographic key, as described herein. Cryptographic circuitry 718 may then encrypt or decrypt the input data block 734, as described herein, and may provide the encrypted or decrypted output data block 736 to the processor 710. For example, data block may be encrypted prior to transmission via communication interface 712. In another example, data received via communication interface 712 may be decrypted prior to use by, e.g., app 724. Thus, cryptographic circuitry 718 may be configured to provide cryptographic functionality to device 702.

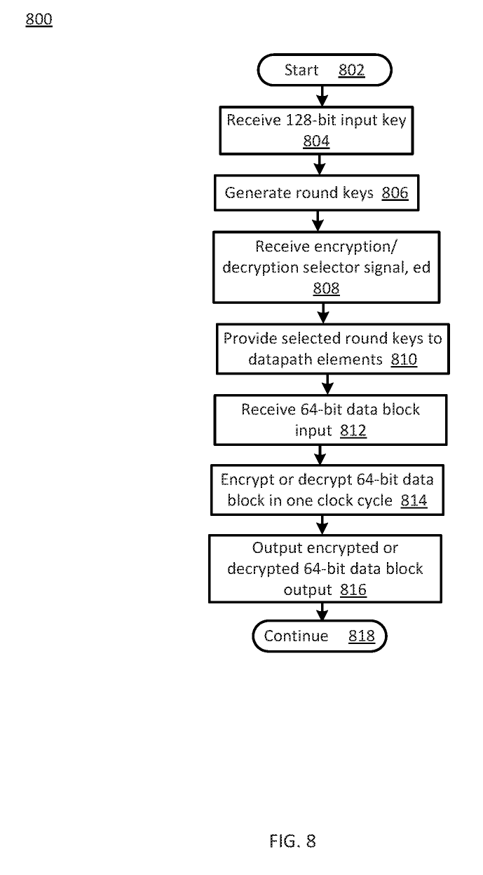

FIG. 8 is a flowchart 800 of cryptographic operations according to various embodiments of the present disclosure. In particular, the flowchart 800 illustrates operation of a cryptographic engine, e.g., cryptographic engine 100 of FIG. 1. The operations may be performed, for example, by cryptographic engine 100 of FIG. 1 and/or device 702 of FIG. 7.

Operations of this embodiment may begin with start 802. A 128-bit input key may be received at operation 804. Round keys may be generated at operation 806. For example, a first round key and a second round key may correspond to the respective portions of the 128-bit input key. Continuing with this example, a third round key may be generated based, at least in part, on the first round key and a fourth round key may be generated based, at least in part, on the second round key.

An encryption/decryption selector signal, ed, may be received at operation 808. The encryption/decryption selector signal may configure a cryptographic engine for encryption or decryption by selecting appropriate round keys, as described herein. Selected round keys may be provided to datapath elements at operation 810. Datapath elements may include, for example, mixers. A 64-bit input data block may be received at operation 812. The 64-bit data block may be encrypted or decrypted in one clock cycle at operation 814. The encrypted or decrypted 64-bit data block output may be output at operation 816. Program flow may then continue in operation 818.

Thus, a 64-bit data block may be encrypted or decrypted utilizing a 128-bit input key in one clock cycle.

While the flowchart of FIG. 8 illustrates operations according various embodiments, it is to be understood that not all of the operations depicted in FIG. 8 is necessary for other embodiments. In addition, it is fully contemplated herein that in other embodiments of the present disclosure, the operations depicted in FIG. 8 and/or other operations described herein may be combined in a manner not specifically shown in any of the drawings, and such embodiments may include less or more operations than are illustrated in FIG. 8. Thus, claims directed to features and/or operations that are not exactly shown in one drawing are deemed within the scope and content of the present disclosure.

As used in any embodiment herein, the term “logic” may refer to an app, software, firmware and/or circuitry configured to perform any of the aforementioned operations. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in memory devices.

“Circuitry”, as used in any embodiment herein, may comprise, for example, singly or in any combination, hardwired circuitry, programmable circuitry such as computer processors comprising one or more individual instruction processing cores, state machine circuitry, and/or firmware that stores instructions executed by programmable circuitry. The logic may, collectively or individually, be embodied as circuitry that forms part of a larger system, for example, an integrated circuit (IC), an application-specific integrated circuit (ASIC), a system on-chip (SoC), desktop computers, laptop computers, tablet computers, phablet computers, servers, smart phones, etc.

The foregoing provides example system architectures and methodologies, however, modifications to the present disclosure are possible. The processor may include one or more processor cores and may be configured to execute system software. System software may include, for example, an operating system. Device memory may include I/O memory buffers configured to store one or more data packets that are to be transmitted by, or received by, a network interface.

The operating system (OS) may be configured to manage system resources and control tasks that are run on, e.g., device 702. For example, the OS may be implemented using Microsoft® Windows®, HP-UX®, Linux®, or UNIX®, although other operating systems may be used. In another example, the OS may be implemented using Android™, iOS, Windows Phone® or BlackBerry®. In some embodiments, the OS may be replaced by a virtual machine monitor (or hypervisor) which may provide a layer of abstraction for underlying hardware to various operating systems (virtual machines) running on one or more processing units.

Memory 714 may each include one or more of the following types of memory: semiconductor firmware memory, programmable memory, non-volatile memory, read only memory, electrically programmable memory, random access memory, flash memory, magnetic disk memory, and/or optical disk memory. Either additionally or alternatively system memory may include other and/or later-developed types of computer-readable memory.

Embodiments of the operations described herein may be implemented in a computer-readable storage device having stored thereon instructions that when executed by one or more processors perform the methods. The processor may include, for example, a processing unit and/or programmable circuitry. The storage device may include a machine readable storage device including any type of tangible, non-transitory storage device, for example, any type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, magnetic or optical cards, or any type of storage devices suitable for storing electronic instructions.

In some embodiments, a hardware description language (HDL) may be used to specify circuit and/or logic implementation(s) for the various logic and/or circuitry described herein. For example, in one embodiment the hardware description language may comply or be compatible with a very high speed integrated circuits (VHSIC) hardware description language (VHDL) that may enable semiconductor fabrication of one or more circuits and/or logic described herein. The VHDL may comply or be compatible with IEEE Standard 1076-1987, IEEE Standard 1076.2, IEEE1076.1, IEEE Draft 3.0 of VHDL-2006, IEEE Draft 4.0 of VHDL-2008 and/or other versions of the IEEE VHDL standards and/or other hardware description standards.

In some embodiments, a Verilog hardware description language (HDL) may be used to specify circuit and/or logic implementation(s) for the various logic and/or circuitry described herein. For example, in one embodiment, the HDL may comply or be compatible with IEEE standard 62530-2011: SystemVerilog—Unified Hardware Design, Specification, and Verification Language, dated Jul. 7, 2011; IEEE Std 1800™-2012: IEEE Standard for SystemVerilog-Unified Hardware Design, Specification, and Verification Language, released Feb. 21, 2013; IEEE standard 1364-2005: IEEE Standard for Verilog Hardware Description Language, dated Apr. 18, 2006 and/or other versions of Verilog HDL and/or SystemVerilog standards.

### EXAMPLES

Examples of the present disclosure include subject material such as a method, means for performing acts of the method, a device, or of an apparatus or system related to a single clock cycle cryptographic engine, as discussed below.

### Example 1

According to this example, there is provided an apparatus. The apparatus includes a cryptographic engine to encrypt or decrypt a 64-bit input data block based, at least in part, on a 128-bit input key. The cryptographic engine includes an input stage, a first group of rounds, a middle stage, a second group of inverse rounds, and an output stage. Each round of the first group of rounds includes a first substitution box (“sbox”) stage, a first matrix multiplication stage, a row permutation stage and a first plurality of mixers. The middle stage includes a second sbox stage, a third matrix multiplication stage and a first inverse sbox stage. Each inverse round of the second group of inverse rounds includes a second plurality of mixers, an inverse row permutation stage, a second matrix multiplication stage and a second inverse sbox stage. Each sbox stage includes a plurality of sbox portions. Each sbox portion includes a first number of combinational logic gates and each inverse sbox stage includes a plurality of inverse sbox portions. Each inverse sbox portion includes a second number of combinational logic gates.

### Example 2

This example includes the elements of example 1, wherein the cryptographic engine further includes a plurality of multiplexers, each multiplexer to receive a respective two round keys and to select one round key for output based, at least in part, on an encryption/decryption selector signal, each round key related to the 128-bit input key.

### Example 3

This example includes the elements of example 1, wherein each matrix multiplication stage includes 64 pairs of multiplication stage mixers coupled in parallel, each pair of mixers coupled in series and each pair of mixers to receive a respective three bits of an intermediate data block.

### Example 4

This example includes the elements of example 1, wherein the cryptographic engine is to encrypt or decrypt the 64-bit input data block in one clock cycle.

### Example 5

This example includes the elements of example 4, wherein one clock cycle is less than or equal to five nanoseconds.

### Example 6

This example includes the elements according to any one of examples 1 through 5, wherein a critical path of the cryptographic engine includes at most 110 gates.

### Example 7

This example includes the elements according to any one of examples 1 through 5, wherein the first number of combinational logic gates is 37 and the second number of combinational logic gates is 40.

### Example 8

This example includes the elements according to any one of examples 1 through 5, wherein each matrix multiplication stage is to multiply an intermediate 64-bit data block by a multiplication matrix using a binary tree procedure.

### Example 9

This example includes the elements according to any one of examples 1 through 5, wherein the cryptographic engine includes at most 7000 gates.

### Example 10

This example includes the elements according to any one of examples 1 through 5, wherein each sbox portion includes AND, OR and negation logic gates to receive a respective four input bits, x3, x2, x1 and x0, and to determine four output bits, Sx3, Sx2, Sx1 and Sx0 as

Sx₀= [symbol] (x₃+x₂+x₁)+(x₃· [symbol] x₁·x₀)+( [symbol] x₃·x₂·x₁)+( [symbol] x₃·x₁· [symbol] x₀)+(x₂·x₁· [symbol] x₀)

Sx₁= [symbol] (x₃+x₂)+ [symbol] (x₁+x₀)+( [symbol] x₂· [symbol] x₁·x₀)

Sx₂=(x₃·x₂)+( [symbol] x₁·x₀)+(x₃· [symbol] x₁· [symbol] x₀)

Sx₃= [symbol] (x₃+x₁)+(x₂· [symbol] x₁· [symbol] x₀)+(x₃·x₁· [symbol] x₀)+(x₂·x₁· [symbol] x₀),

“ [symbol] ” corresponds to negation, “+” corresponds to OR and “·” corresponds to AND.

### Example 11

This example includes the elements according to any one of examples 1 through 5, wherein each inverse sbox portion includes AND, OR and negation logic gates to receive a respective four input bits, x3, x2, x1 and x0, and to determine four output bits, S⁻¹x3, S⁻¹x2, S⁻¹x1 and S⁻¹x0 as

Sx⁻¹₀= [symbol] (x₃+x₁)+(x₂· [symbol] x₁· [symbol] x₀)+(x₂·x₁·x₀)+ [symbol] (x₃+x₂+x₀)

Sx⁻¹₁= [symbol] (x₃+x₂)+ [symbol] (x₃+x₁+x₀)+ [symbol] (x₂+x₁+x₀)+(x₃· [symbol] x₁·x₀)

Sx⁻¹₂=( [symbol] x₁·x₀)+(x₂· [symbol] x₁· [symbol] x₀)+(x₃·x₁· [symbol] x₀)

Sx⁻¹₃=( [symbol] x₃·x₂)+ [symbol] (x₃+x₁+x₀)+ [symbol] (x₂+x₁+x₀)+(x₂· [symbol] x₁·x₀)+(x₂·x₁· [symbol] x₀),

“ [symbol] ” corresponds to negation, “+” corresponds to OR and “·” corresponds to AND.

### Example 12

This example includes the elements according to any one of examples 1 through 5, wherein each row permutation stage includes interconnect circuitry.

### Example 13

This example includes the elements according to any one of examples 1 through 5, wherein each inverse row permutation stage includes interconnect circuitry.

### Example 14

This example includes the elements according to any one of examples 1 through 5, wherein the first plurality of mixers and the second plurality of mixers each includes a first mixer to receive a round key and a round constant and a second mixer to receive an output of the first mixer and an output of a respective pair of multiplication stage mixers.

### Example 15

According to this example, there is provided a method. The method includes receiving, by a cryptographic engine, a 64-bit input data block; encrypting or decrypting, by the cryptographic engine, the 64-bit input data block based, at least in part, on a 128-bit input key; and outputting, by the cryptographic engine, a 64-bit encrypted or decrypted output data block. The cryptographic engine includes an input stage, a first group of rounds, a middle stage, a second group of inverse rounds, and an output stage. Each round of the first group of rounds includes a first substitution box (“sbox”) stage, a first matrix multiplication stage, a row permutation stage and a first plurality of mixers. The middle stage includes a second sbox stage, a third matrix multiplication stage and a first inverse sbox stage. Each inverse round of the second group of rounds includes a second plurality of mixers, an inverse row permutation stage, a second matrix multiplication stage and a second inverse sbox stage. Each sbox stage includes a plurality of sbox portions. Each sbox portion includes a first number of combinational logic gates and each inverse sbox stage includes a plurality of inverse sbox portions. Each inverse sbox portion includes a second number of combinational logic gates.

### Example 16

This example includes the elements of example 15, and further includes receiving, by each multiplexer of a plurality of multiplexers, a respective two round keys and selecting, by each multiplexer, one round key for output based, at least in part, on an encryption/decryption selector signal, each round key related to the 128-bit input key.

### Example 17

This example includes the elements of example 15, and further includes receiving, by each pair of mixers of 64 multiplication stage mixers, a respective three bits of an intermediate data block, each pair of mixers coupled in series.

### Example 18

This example includes the elements of example 15, wherein the cryptographic engine is to encrypt or decrypt the 64-bit input data block in one clock cycle.

### Example 19

This example includes the elements of example 18, wherein one clock cycle is less than or equal to five nanoseconds.

### Example 20

This example includes the elements of example 15, wherein a critical path of the cryptographic engine includes at most 110 gates.

### Example 21

This example includes the elements of example 15, wherein the first number of combinational logic gates is 37 and the second number of combinational logic gates is 40.

### Example 22

This example includes the elements of example 15, wherein each matrix multiplication stage is to multiply an intermediate 64-bit data block by a multiplication matrix using a binary tree procedure.

### Example 23

This example includes the elements of example 15, wherein the cryptographic engine includes at most 7000 gates.

### Example 24

This example includes the elements of example 15, and further includes receiving, by each sbox portion, a respective four input bits, x3, x2, x1 and x0, and determining, by each sbox portion, four output bits, Sx3, Sx2, Sx1 and Sx0 as

Sx₀= [symbol] (x₃+x₂+x₁)+(x₃· [symbol] x₁·x₀)+( [symbol] x₃·x₂·x₁)+( [symbol] x₃·x₁· [symbol] x₀)+(x₂·x₁· [symbol] x₀)

Sx₁= [symbol] (x₃+x₂)+ [symbol] (x₁+x₀)+( [symbol] x₂· [symbol] x₁·x₀)

Sx₂=(x₃·x₂)+( [symbol] x₁·x₀)+(x₃· [symbol] x₁·x₀)

Sx₃= [symbol] (x₃+x₁)+(x₂· [symbol] x₁· [symbol] x₀)+(x₃·x₁· [symbol] x₀)+(x₂·x₁· [symbol] x₀),

wherein each sbox portion includes AND, OR and negation logic gates and “ [symbol] ” corresponds to negation, “+” corresponds to OR and “·” corresponds to AND.

### Example 25

This example includes the elements of example 15, and further includes receiving, by each inverse sbox portion, a respective four input bits, x3, x2, x1 and x0, and determining, by each inverse sbox portion, four output bits, S⁻¹x3, S⁻¹x2, S⁻¹x1 and S⁻¹x0 as

Sx⁻¹₀= [symbol] (x₃+x₁)+(x₂· [symbol] x₁· [symbol] x₀)+(x₂·x₁·x₀)+ [symbol] (x₃+x₂+x₀)

Sx⁻¹₁= [symbol] (x₃+x₂)+ [symbol] (x₃+x₁+x₀)+ [symbol] (x₂+x₁+x₀)+(x₃· [symbol] x₁·x₀)

Sx⁻¹₂=( [symbol] x₁·x₀)+(x₂· [symbol] x₁· [symbol] x₀)+(x₃·x₁· [symbol] x₀)

Sx⁻¹₃=( [symbol] x₃·x₂)+ [symbol] (x₃+x₁+x₀)+ [symbol] (x₂+x₁+x₀)+(x₂· [symbol] x₁·x₀)+(x₂·x₁· [symbol] x₀),

wherein each inverse sbox portion includes AND, OR and negation logic gates and “ [symbol] ” corresponds to negation, “+” corresponds to OR and “·” corresponds to AND.

### Example 26

This example includes the elements of example 15, wherein each row permutation stage includes interconnect circuitry.

### Example 27

This example includes the elements of example 15, wherein each inverse row permutation stage includes interconnect circuitry.

### Example 28

This example includes the elements of example 15, and further includes receiving, by a first mixer of each of the first plurality of mixers and the second plurality of mixers, a round key and a round constant and receiving, by a second mixer of each of the first plurality of mixers and the second plurality of mixers, an output of the first mixer and an output of a respective pair of multiplication stage mixers.

### Example 29

According to this example, there is provided a device. The device includes a processor, a clock, and a cryptographic engine to encrypt or decrypt a 64-bit input data block based, at least in part, on a 128-bit input key. The cryptographic engine includes an input stage, a first group of rounds, a middle stage, a second group of inverse rounds, and an output stage. Each round of the first group of rounds includes a first substitution box (“sbox”) stage, a first matrix multiplication stage, a row permutation stage and a first plurality of mixers. The middle stage includes a second sbox stage, a third matrix multiplication stage and a first inverse sbox stage. Each inverse round of the second group of inverse rounds includes a second plurality of mixers, an inverse row permutation stage, a second matrix multiplication stage and a second inverse sbox stage. Each sbox stage includes a plurality of sbox portions. Each sbox portion includes a first number of combinational logic gates; each inverse sbox stage includes a plurality of inverse sbox portions; and each inverse sbox portion includes a second number of combinational logic gates.

### Example 30

This example includes the elements of example 29, wherein the cryptographic engine further includes a plurality of multiplexers, each multiplexer to receive a respective two round keys and to select one round key for output based, at least in part, on an encryption/decryption selector signal, each round key related to the 128-bit input key.

### Example 31

This example includes the elements of example 29, wherein each matrix multiplication stage includes 64 pairs of multiplication stage mixers coupled in parallel, each pair of mixers coupled in series and to receive a respective three bits of an intermediate data block.

### Example 32

This example includes the elements of example 29, wherein the cryptographic engine is to encrypt or decrypt the 64-bit input data block in one clock cycle.

### Example 33

This example includes the elements of example 32, wherein one clock cycle is less than or equal to five nanoseconds.

### Example 34

This example includes the elements according to any one of examples 29 through 33, wherein a critical path of the cryptographic engine includes at most 110 gates.

### Example 35

This example includes the elements according to any one of examples 29 through 33, wherein the first number of combinational logic gates is 37 and the second number of combinational logic gates is 40.

### Example 36

This example includes the elements according to any one of examples 29 through 33, wherein each matrix multiplication stage is to multiply an intermediate 64-bit data block by a multiplication matrix using a binary tree procedure.

### Example 37

This example includes the elements according to any one of examples 29 through 33, wherein the cryptographic engine includes at most 7000 gates.

### Example 38

This example includes the elements according to any one of examples 29 through 33, wherein each sbox portion includes AND, OR and negation logic gates to receive a respective four input bits, x3, x2, x1 and x0, and to determine four output bits, Sx3, Sx2, Sx1 and Sx0 as

Sx₀= [symbol] (x₃+x₂+x₁)+(x₃· [symbol] x₁·x₀)+( [symbol] x₃·x₂·x₁)+( [symbol] x₃·x₁· [symbol] x₀)+(x₂·x₁· [symbol] x₀)

Sx₁= [symbol] (x₃+x₂)+ [symbol] (x₁+x₀)+( [symbol] x₂· [symbol] x₁·x₀)

Sx₂=(x₃·x₂)+( [symbol] x₁·x₀)+(x₃· [symbol] x₁· [symbol] x₀)

Sx₃= [symbol] (x₃+x₁)+(x₂· [symbol] x₁· [symbol] x₀)+(x₃·x₁· [symbol] x₀)+(x₂x₁· [symbol] x₀),

“ [symbol] ” corresponds to negation, “+” corresponds to OR and “·” corresponds to AND.

### Example 39

This example includes the elements according to any one of examples 29 through 33, wherein each inverse sbox portion includes AND, OR and negation logic gates to receive a respective four input bits, x3, x2, x1 and x0, and to determine four output bits, S⁻¹x3, S⁻¹x2, S⁻¹x1 and S⁻¹x0 as

Sx⁻¹₀= [symbol] (x₃+x₁)+(x₂· [symbol] x₁· [symbol] x₀)+(x₂·x₁·x₀)+ [symbol] (x₃+x₂+x₀)

Sx⁻¹₁= [symbol] (x₃+x₂)+ [symbol] (x₃+x₁+x₀)+ [symbol] (x₂+x₁+x₀)+(x₃· [symbol] x₁·x₀)

Sx⁻¹₂=( [symbol] x₁·x₀)+(x₂· [symbol] x₁· [symbol] x₀)+(x₃·x₁· [symbol] x₀)

Sx⁻¹₃=( [symbol] x₃·x₂)+ [symbol] (x₃+x₁+x₀)+ [symbol] (x₂+x₁+x₀)+(x₂· [symbol] x₁·x₀)+(x₂·x₁· [symbol] x₀),

“ [symbol] ” corresponds to negation, “+” corresponds to OR and “·” corresponds to AND.

### Example 40

This example includes the elements according to any one of examples 29 through 33, wherein each row permutation stage includes interconnect circuitry.

### Example 41

This example includes the elements according to any one of examples 29 through 33, wherein each inverse row permutation stage includes interconnect circuitry.

### Example 42

This example includes the elements according to any one of examples 29 through 33, wherein the first plurality of mixers and the second plurality of mixers each includes a first mixer to receive a round key and a round constant and a second mixer to receive an output of the first mixer and an output of a respective pair of multiplication stage mixers.

### Example 43

According to this example, there is provided a system. The system includes at least one device arranged to perform the method of any one of examples 15 to 28.

### Example 44

According to this example, there is provided a device. The device includes means to perform the method of any one of examples 15 to 28.

### Example 45

According to this example, there is provided a computer readable storage device. The computer readable storage device having stored thereon instructions that when executed by one or more processors result in the following operations, including: the method according to any one of examples 15 through 28.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications.

What is claimed is:

1. An apparatus comprising:
a cryptographic engine to encrypt or decrypt a 64-bit input data block based, at least in part, on a 128-bit input key, the cryptographic engine comprising:
an input stage;
a first group of rounds, each round comprising a first substitution box (“sbox”) stage, a first matrix multiplication stage, a row permutation stage and a first plurality of mixers;
a middle stage comprising a second sbox stage, a third matrix multiplication stage and a first inverse sbox stage;
a second group of inverse rounds, each inverse round comprising a second plurality of mixers, an inverse row permutation stage, a second matrix multiplication stage and a second inverse sbox stage; and
an output stage,
each sbox stage comprising a plurality of sbox portions, each sbox portion comprising a first number of combinational logic gates and each inverse sbox stage comprising a plurality of inverse sbox portions, each inverse sbox portion comprising a second number of combinational logic gates.

2. The apparatus of claim 1, wherein the cryptographic engine further comprises a plurality of multiplexers, each multiplexer to receive a respective two round keys and to select one round key for output based, at least in part, on an encryption/decryption selector signal, each round key related to the 128-bit input key.

3. The apparatus of claim 1, wherein each matrix multiplication stage comprises 64 pairs of multiplication stage mixers coupled in parallel, each pair of mixers coupled in series and each pair of mixers to receive a respective three bits of an intermediate data block.

4. The apparatus of claim 1, wherein the cryptographic engine is to encrypt or decrypt the 64-bit input data block in one clock cycle.

5. The apparatus of claim 4, wherein one clock cycle is less than or equal to five nanoseconds.

6. The apparatus of claim 1, wherein a critical path of the cryptographic engine comprises at most 110 gates.

7. The apparatus of claim 1, wherein the first number of combinational logic gates is 37 and the second number of combinational logic gates is 40.

8. A method comprising:
receiving, by a cryptographic engine, a 64-bit input data block;
encrypting or decrypting, by the cryptographic engine, the 64-bit input data block based, at least in part, on a 128-bit input key; and
outputting, by the cryptographic engine, a 64-bit encrypted or decrypted output data block,
the cryptographic engine comprising an input stage; a first group of rounds, each round comprising a first substitution box (“sbox”) stage, a first matrix multiplication stage, a row permutation stage and a first plurality of mixers; a middle stage comprising a second sbox stage, a third matrix multiplication stage and a first inverse sbox stage; a second group of inverse rounds, each inverse round comprising a second plurality of mixers, an inverse row permutation stage, a second matrix multiplication stage and a second inverse sbox stage; and an output stage, each sbox stage comprising a plurality of sbox portions, each sbox portion comprising a first number of combinational logic gates and each inverse sbox stage comprising a plurality of inverse sbox portions, each inverse sbox portion comprising a second number of combinational logic gates.

9. The method of claim 8, further comprising receiving, by each multiplexer of a plurality of multiplexers, a respective two round keys and selecting, by each multiplexer, one round key for output based, at least in part, on an encryption/decryption selector signal, each round key related to the 128-bit input key.

10. The method of claim 8, further comprising receiving, by each pair of mixers of 64 multiplication stage mixers, a respective three bits of an intermediate data block, each pair of mixers coupled in series.

11. The method of claim 8, wherein the cryptographic engine is to encrypt or decrypt the 64-bit input data block in one clock cycle.

12. The method of claim 11, wherein one clock cycle is less than or equal to five nanoseconds.

13. The method of claim 8, wherein a critical path of the cryptographic engine comprises at most 110 gates.

14. The method of claim 8, wherein the first number of combinational logic gates is 37 and the second number of combinational logic gates is 40.

15. A device comprising:
a processor;
a clock; and
a cryptographic engine to encrypt or decrypt a 64-bit input data block based, at least in part, on a 128-bit input key, the cryptographic engine comprising:
an input stage;
a first group of rounds, each round comprising a first substitution box (“sbox”) stage, a first matrix multiplication stage, a row permutation stage and a first plurality of mixers;
a middle stage comprising a second sbox stage, a third matrix multiplication stage and a first inverse sbox stage;
a second group of inverse rounds, each inverse round comprising a second plurality of mixers, an inverse row permutation stage, a second matrix multiplication stage and a second inverse sbox stage; and
an output stage,
each sbox stage comprising a plurality of sbox portions, each sbox portion comprising a first number of combinational logic gates and each inverse sbox stage comprising a plurality of inverse sbox portions, each inverse sbox portion comprising a second number of combinational logic gates.

16. The device of claim 15, wherein the cryptographic engine further comprises a plurality of multiplexers, each multiplexer to receive a respective two round keys and to select one round key for output based, at least in part, on an encryption/decryption selector signal, each round key related to the 128-bit input key.

17. The device of claim 15, wherein each matrix multiplication stage comprises 64 pairs of multiplication stage mixers coupled in parallel, each pair of mixers coupled in series and to receive a respective three bits of an intermediate data block.

18. The device of claim 15, wherein the cryptographic engine is to encrypt or decrypt the 64-bit input data block in one clock cycle.

19. The device of claim 18, wherein one clock cycle is less than or equal to five nanoseconds.

20. The device of claim 15, wherein a critical path of the cryptographic engine comprises at most 110 gates.

21. The device of claim 15, wherein the first number of combinational logic gates is 37 and the second number of combinational logic gates is 40.
